(19) United States
(12) Patent Application Publication
(10) Pub. No.: US 2005/0255278 A1
(43) Pub. Date: Nov. 17, 2005

(54) Adhesive film, lead frame with adhesive film, and semiconductor device using same

(76) Inventors: Hidekazu Matsuura, Ichihara-shi (JP); Kiyohide Tateoka, Ichihara-shi (JP); Tomohiro Nagoya, Ichihara-shi (JP); Yoshiyuki Tanabe, Ichihara-shi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/119,943

(22) Filed: May 3, 2005

(30) Foreign Application Priority Data
May 11, 2004 (JP) P2004-141179
Mar. 9, 2005 (JP) P2005-66328

(51) Int. Cl. B32B 3/02; B32B 27/36; B32B 27/34; B32B 27/06; B32B 15/04

(52) U.S. Cl. 428/45; 428/343; 428/354; 428/480; 428/473.5; 428/474.4; 428/411.1; 428/327; 428/447

(57) ABSTRACT

The present invention provides an adhesive film that combines low temperature adhesion with favorable wire bonding characteristics. The adhesive film used for bonding a semiconductor element to a target adherend comprises an adhesive layer formed on one surface, or both surfaces, of a heat resistant film, the adhesive layer comprises a resin A and a resin B, a glass transition temperature of the resin A is lower than a glass transition temperature of the resin B, and the adhesive layer has a sea-island structure, in which the resin A forms the sea, and the resin B forms the islands.

### BACKGROUND OF THE INVENTION

1. Field of the Invention

The present invention relates to an adhesive film, a lead frame with an adhesive film, and a semiconductor device using the same.

2. Description of the Related Art

In recent years, increases in the functionality and capacity of semiconductor chips has lead to larger chips. In contrast, packages for such semiconductor chips are required to be as small as possible, in order to meet constraints on printed circuit board designs, and demands for small electronic devices. These trends have resulted in a number of new mounting systems being proposed, to enable higher density integrating and higher density mounting of semiconductor chips. Examples of these new systems include LOC structures, in which leads are bonded onto chips within memory elements, CSP systems such as μ-BGA, FBGA, and BOC, wherein a film or organic substrate is used instead of a lead frame, and stacked packages that use layered chip structures. These systems enable rationalization of chip internal wiring and wire bonding, higher signal transmission speeds due to shorter wiring, and reduced package sizes.

In these new systems, an adhesion interface exists between the semiconductor chip and the lead frame, which are composed of different materials. The adhesion reliability at this interface has a very large effect on the reliability of the semiconductor package. The adhesion interface is desired not only to be capable of withstanding the process temperatures reached during package assembly, but also to have good adhesion workability, and enable superior wire bond connection between the semiconductor chip and the lead frame.

Conventionally, a paste adhesive, or an adhesive applied to a heat resistant substrate has been used for this adhesion. Suitable examples include hot-melt adhesive films that use a polyimide resin (for example, see Japanese Laid-Open Publication No. Hei 5-105850, Japanese Laid-Open Publication No. Hei 5-112760, and Japanese Laid-Open Publication No. Hei 5-112761). However, in hot-melt adhesive films, the adhesive resin tends to have a high Tg, meaning the temperature required for adhesion is very high. Unfortunately, this means that target adherends such as recent high density semiconductor chips and copper lead frames may suffer thermal damage.

Adhesives that comprise a resin with a low glass transition temperature, thereby satisfying the requirement for low temperature adhesion, are also known. However, these resins tend to soften at wire bonding temperatures, meaning electrically connecting the semiconductor chip and the lead frame during the wire bonding step of the package production process can be difficult.

### SUMMARY OF THE INVENTION

An object of the present invention is to provide an adhesive film that combines low temperature adhesion with favorable wire bonding characteristics.

Another object of the present invention is to provide a lead frame with the above attached adhesive film.

Yet another object of the present invention is to provide a semiconductor device comprising a lead frame and a semiconductor element bonded together via the above adhesive film.

Based on research into the development of adhesive films capable of providing both low temperature adhesion and favorable wire bonding characteristics, the inventors of the present invention found that an adhesive film using two specific resins that undergo a phase separation within a film state is able to achieve the objects described above.

In other words, the present invention relates to an adhesive film used for bonding a semiconductor element to a target adherend, wherein the adhesive film comprises an adhesive layer formed on either one surface, or both surfaces, of a heat resistant film, the adhesive layer comprises a resin A and a resin B, the glass transition temperature of the resin A is lower than the glass transition temperature of the resin B, and the adhesive layer has a sea-island structure, in which the resin A forms the sea phase, and the resin B forms the island phase.

Furthermore, the present invention also relates to the above adhesive film, wherein one of the resins A and B is a polyamideimide, a polyamide, an aromatic polyester (a polyacrylate), a polysulfone, a polyethersulfone, or a mixed resin comprising two or more of these polymers.

The present invention also relates to the above adhesive film, wherein both the resins A and B are a polyamideimide, a polyamide, an aromatic polyester (a polyacrylate), a polysulfone, a polyethersulfone, or a mixed resin comprising two or more of these polymers.

The present invention also relates to the above adhesive film, wherein at least one of the resins A and B is a polyamideimide, a polyamide, or a mixed resin thereof.

The present invention also relates to the above adhesive film, wherein the resin A is a polyamideimide, a polyamide, or a mixed resin thereof.

The present invention also relates to the above adhesive film, wherein the resin A is a polymer produced by the polymerization of a monomer component comprising from 10 to 80% by weight of monomers with a silicone structure.

The present invention also relates to the above adhesive film, wherein the resin B is a polymer produced by the polymerization of a monomer component comprising 0% or more but less than 10% by weight of monomers with a silicone structure.

The present invention also relates to the above adhesive film, wherein the glass transition temperature of the resin A is at least 30° C. but less than 200° C., and the glass transition temperature of the resin B is within a range from 200 to 400° C.

The present invention also relates to the above adhesive film, wherein the difference between the glass transition temperatures of the resins A and B is within a range from 20 to 300° C.

The present invention also relates to the above adhesive film, wherein the storage modulus of the adhesive layer is within a range from 3 MPa to 10 GPa at any temperature of 150° C. or higher.

The present invention also relates to the above adhesive film, wherein the adhesive layer also comprises a coupling agent.

The present invention also relates to the above adhesive film, wherein the coupling agent is a silane coupling agent.

Furthermore, the present invention also relates to a lead frame with an adhesive film, comprising a lead frame, and the above adhesive film bonded to the lead frame.

In addition, the present invention also relates to a semiconductor device in which a lead frame and a semiconductor element are bonded together using the above adhesive film.

The present disclosure relates to subject matter contained in Japanese Patent Application No. 2004-141179, filed on May 11, 2004 and Japanese Patent Application No. 2005-066328, filed on Mar. 9, 2005, the disclosure of which is expressly incorporated herein by reference in its entirety.

### BRIEF DESCRIPTION OF THE DRAWINGS

FIG. 1 is a set of cross-sectional views showing embodiments of adhesive films of the present invention, wherein (a) represents an example in which an adhesive layer is laminated to one surface of a heat resistant film, and (b) represents an example in which separate adhesive layers are laminated to both surfaces of a heat resistant film;

FIG. 2 is a cross-sectional view showing an embodiment of a semiconductor device using an adhesive film of the present invention;

FIG. 3 is a photograph of the exterior of an adhesive layer from an example 2;

FIG. 4 is a graph showing the elastic modulus of the adhesive layer of the example 2;

FIG. 5 is a photograph of the exterior of an adhesive layer from an example 3;

FIG. 6 is a graph showing the elastic modulus of the adhesive layers of the examples 7 and 8;

FIG. 7 is a TMA chart for the adhesive layer of the example 7; and

FIG. 8 is a scanning electron microscope photograph showing a cross-section of the adhesive layer of the example 8.

### DETAILED DESCRIPTION OF THE PREFERRED EMBODIMENTS

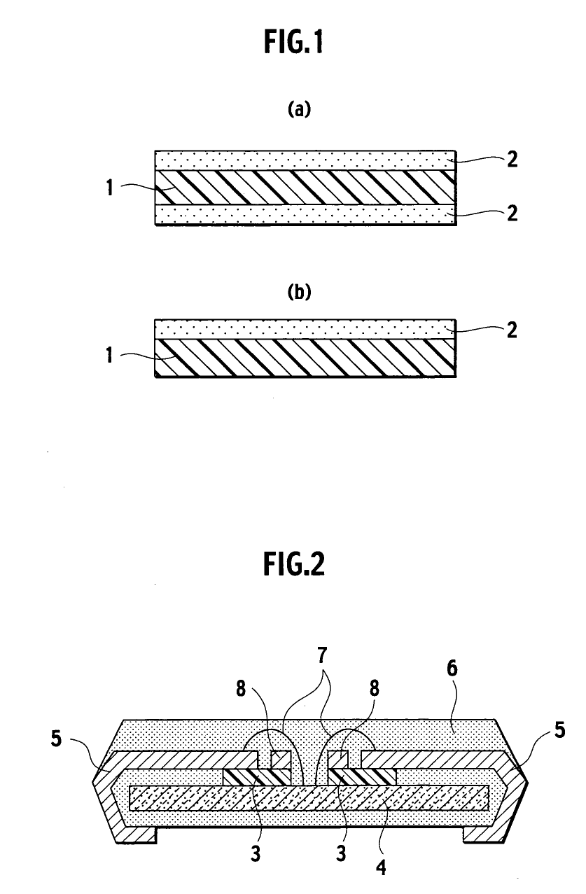

An adhesive film of the present invention is used for bonding a semiconductor element to a target adherend. FIG. 1(a) and FIG. 1(b) show two possible configurations for an embodiment of the present invention. In both figures, numeral 1 represents a heat resistant film, and numeral 2 represents an adhesive layer. There are no particular restrictions on the target adhered to which the semiconductor element is bonded, and suitable examples include a lead frame, a film, an organic substrate, or another semiconductor element.

In the present invention, the adhesive layer formed on either one surface, or both surfaces, of the heat resistant film comprises a resin A and a resin B, wherein the glass transition temperature of the resin A is lower than that of the resin B, and the adhesive layer has a sea-island structure (an islands-in-sea structure), in which the resin A forms the sea phase, and the resin B forms the island phase. As follows, this adhesive film of the present invention is described in detail, with reference to specific embodiments.

In an adhesive film of the present invention, the adhesive layer has a sea-island structure, in which the resin A forms the sea phase, and the resin B forms the island phase, and moreover, the glass transition temperature of the resin A is lower than that of the resin B. In other words, in the sea-island structure, the glass transition temperature of the island phase is set to a higher value than the glass transition temperature of the sea phase. By employing such a configuration, an adhesive film of the present invention is able to provide a combination of low temperature adhesion and favorable wire bonding characteristics.

In the present invention, the resins A and B are preferably selected from among the various heat resistant thermoplastic resins. Examples of such heat resistant thermoplastic resins include the so-called engineering plastics, such as polyimides, polyetherimides, polyesterimides, polyamides, polyamideimides, aromatic polyesters (polyacrylates), polysulfones, and polyethersulfones.

The resins A and B exist in a phase-separated state within the adhesive film. Mixed resins comprising 2 or more different resins can also be used as the resins A and B.

From the viewpoints of adhesiveness and solubility, polyamideimides, polyamides, aromatic polyesters (polyacrylates), polysulfones, and polyethersulfones are preferred to polyimides.

In one embodiment of the present invention, either the resin A or the resin B uses a resin selected from a group consisting of polyamideimides, polyamides, aromatic polyesters (polyacrylates), polysulfones, and polyethersulfones, or a mixed resin of two or more such resins, and this embodiment is preferred in terms of adhesion. In another embodiment of the present invention, both of the resins A and B use a resin selected from a group consisting of polyamideimides, polyamides, aromatic polyesters (polyacrylates), polysulfones, and polyethersulfones, or a mixed resin of two or more such resins, and this embodiment is also preferred in terms of adhesion.

In yet another embodiment of the present invention, at least one of the resins A and B uses an amide group-containing resin such as a polyamideimide, a polyamide, or a mixed resin thereof, and this embodiment is preferred in terms of adhesion and package reliability. The reason for this preference is that because an amide is a high polarity group, the interaction between polar groups improves the adhesive strength generated with the target adherend, as well as strengthening the adhesion at the interface between the resin A and the resin B. In addition, amide groups are also reactive, meaning further strengthening of the resin can be expected through weak crosslinking initiated by coupling agents.

Accordingly, in order to further improve the adhesive strength, at least one of the resins A and B is preferably an amide group-containing resin such as a polyamideimide, a polyamide, or a mixed resin thereof.

In those cases where an amide group-containing resin is used for only one of the two resins A and B, then from the viewpoint of adhesiveness, it is preferably used as the resin A that forms the sea phase. This utilizes the effect of the polarity of the amide groups. Furthermore, employing an amide group-containing resin for both of the resins A and B is even more desirable, as this strengthens the interaction between the two resins, reducing the likelihood of any interface separation.

The resins A and B of the present invention are preferably heat resistant resins with glass transition temperatures within a range from 30 to 400° C., and even more preferably from 50 to 350° C. Furthermore, the glass transition temperature of the resin A is preferably at least 30° C. but less than 200° C., whereas the glass transition temperature of the resin B is preferably within a range from 200 to 400° C. In addition, the storage modulus of the resin A, determined by measuring the dynamic viscoelasticity at the wire bonding temperature, is preferably at least 0.1 MPa, whereas the storage modulus of the resin B under the same conditions is preferably at least 10 MPa. As above, these requirements are preferably met by using an amide group-containing resin for either the resin A or the resin B.

In this description, the wire bonding temperature typically refers to a temperature of at least 150° C.

If the glass transition temperature of the resin A is 200° C. or higher, then the low temperature adhesion deteriorates, whereas if the value is less than 30° C., then tackiness tends to develop at room temperature, making handling difficult, and the wire bonding characteristics and reliability are also prone to deterioration. If the storage modulus of the resin A falls below 0.1 MPa, then the wire bonding characteristics may deteriorate.

The glass transition temperature for the resin A is preferably within a range from 60 to 180° C., and even more preferably from 70 to 150° C. Furthermore, a preferred storage modulus for the resin A is within a range from 3 to 3,000 MPa, and even more preferably from 5 to 3,000 MPa.

Furthermore, if the glass transition temperature of the resin B is less than 200° C., or the storage modulus is less than 10 MPa, then the wire bonding characteristics may deteriorate.

The glass transition temperature for the resin B is preferably within a range from 220 to 300° C., and even more preferably from 250 to 300° C. Furthermore, a preferred storage modulus for the resin B is within a range from 20 to 3,000 MPa, and even more preferably from 50 to 3,000 MPa.

The difference between the respective glass transition temperatures of the resin A and the resin B is preferably within a range from 20 to 300° C. If this difference is less than 20° C., then achieving a favorable combination of low temperature adhesion and wire bonding characteristics is difficult, whereas if the difference exceeds 300° C., the wire bonding characteristics and the reliability may deteriorate.

Furthermore, for an adhesive layer of the present invention comprising a resin A and a resin B, the lowest glass transition temperature above room temperature is preferably within a range from 50 to 190° C., and even more preferably from 80 to 190° C., and most preferably from 100 to 185° C. Furthermore, the storage modulus, determined by measuring the dynamic viscoelasticity of the adhesive layer at the wire bonding temperature, is preferably within a range from 3 MPa to 10 GPa, and even more preferably from 3 to 3,000 MPa, and most preferably from 5 to 3,000 MPa.

In the present invention, the glass transition temperature of the adhesive layer comprising the resins A and B can be determined by generating a storage modulus curve by measuring the dynamic viscoelasticity of a single adhesive layer, and then determining the point of intersection of the tangents drawn at the two inflection points of the curve.

An adhesive composition that adopts a sea-island structure within a film state, with the resin A forming the sea, and the resin B forming the islands, is selected by preliminary investigations prior to use. That is, an adhesive composition is selected either on the basis of a phase separation and turbidity being observed when varnishes of the resins A and B are mixed together, or on the basis of a phase-separated structure forming, yielding an opaque adhesive composition layer, when the composition is applied to the surface of a heat resistant film.

By adjusting factors such as the resin concentrations when the varnishes of the resins A and B are mixed together, or the film formation conditions, the size of the islands within the sea-island structure can be controlled.

Selection of the specific combination between the resin A that forms the sea phase, and the resin B that undergoes phase separation from the resin A to form the island phase, can be made on the basis of chemical properties, so that resins comprising components with significantly different chemical structures are combined. Specific examples include combinations of polar groups (polar structures) and non-polar groups (non-polar structures), or combinations of hydrophilic groups (hydrophilic structures) and hydrophobic groups (hydrophobic structures). Alkyl groups, aromatic hydrocarbon groups, fluorine-substituted structures such as fluorine-substituted alkyl groups and fluorine-substituted aromatic hydrocarbon groups, and silicone structures all represent non-polar, hydrophobic components, whereas sulfonyl groups, carbonyl groups, amide groups, ether linkages, and ester linkages all represent polar, hydrophilic components. Accordingly, by choosing a combination of resins produced using monomers with these types of differing chemical properties and structures, a suitable combination of the resins A and B can be achieved.

For example, a combination of a polymer containing a large quantity of silicone structures and a polymer containing effectively no silicone structures undergoes phase separation readily. Examples of monomers containing a large quantity of silicone structures include polymers produced by the polymerization of a monomer component in which at least 10 mol % of all the monomers, and preferably from 10 to 80 mol %, are monomers with a silicone structure. Examples of polymers containing effectively no silicone structures include polymers containing absolutely no silicone structures, and polymers containing a small quantity of silicone structures, produced by the polymerization of a monomer component in which less than 10 mol % of all the monomers, and preferably less than 5 mol %, are monomers with a silicone structure. These non-silicone polymers may contain large quantities of highly polar sulfone groups or ether linkages.

The proportion of monomers with silicone structures among the total of all the monomers used in the production of the resin A is preferably within a range from 10 to 80% by weight. If this proportion exceeds 80% by weight, then the adhesive strength may deteriorate.

Furthermore, even if a combination of polymers that each contain a non-polar, hydrophobic component as the principal component is used, if the structures of the polymers are very different, then phase separation still occurs readily. For example, a combination of a polymer containing a large quantity of silicone structures and a polymer containing bulky alkyl group substituents undergoes phase separation readily. Accordingly, the present invention is not restricted to combinations of polar structures and non-polar structures, or hydrophilic structures and hydrophobic structures, but can employ any combination in which the resins A and B have significantly different structures.

When selecting the combination of the resin A and the resin B, in order to ensure that the glass transition temperature of the resin A is lower than that of the resin B, preferably those factors that influence the glass transition temperature, such as the rigidity of the resin produced by the polymerization of the monomers containing the structures described above, are also considered.

Furthermore, in the present invention, the resin A preferably accounts for 50 to 95% by weight of the combined weight of the resins A and B, with the resin B accounting for 5 to 50% by weight. Relative proportions of 50 to 90% by weight for the resin A, and 10 to 50% by weight for the resin B are even more preferred, and proportions of 50 to 85% by weight for the resin A, and 15 to 50% by weight for the resin B are the most desirable.

The average size of the islands of the resin B within the adhesive layer is preferably no more than 5 μm, and even more preferably within a range from 1 to 0.01 μm. In terms of ensuring good uniformity of the film characteristics, the size of the islands is preferably kept as small as possible, and the islands are preferably dispersed uniformly throughout the layer. Confirmation of the sea-island structure, and measurement of the size of the islands, can be carried out by polishing a cross-section of the adhesive layer, and then observing the cross-section under a scanning electron microscope or the like. The average size of the islands can be measured from the microscope image. Furthermore confirmation of the sea-island structure can also be made on the basis of the storage modulus curve generated by measuring the dynamic viscoelasticity of the film, by identifying the inflection points corresponding with the respective resins A and B.

The polyamideimides and polyamides that represent the preferred materials for the resins A and B are typically synthesized from a diamine (A) and/or a diisocyanate (A′), and an acid component. The acid component can use a tricarboxylic acid, tetracarboxylic acid, or reactive derivative thereof (B), or a dicarboxylic acid or reactive derivative thereof (C). Combinations of a plurality of such acid components can also be used. In the present invention, the various predetermined properties described above can be achieved by altering factors such as the specific combination of reaction components, as well as the relative proportions of the reactants, the reaction conditions, the product molecular weight, the addition of additives to the adhesive and the nature of those additives, and the incorporation of additive resins such as epoxy resins.

Examples of the above diamine (A) include alkylenediamines such as hexamethylenediamine, octamethylenediamine, and dodecamethylenediamine; arylenediamines such as para-phenylenediamine, meta-phenylenediamine, and meta-toluylenediamine; diaminodiphenyl derivatives such as 4,4′-diaminodiphenyl ether (DDE), 4,4′-diaminodiphenylethane, 4,4′-diaminodiphenylsulfone, 3,3′-diaminodiphenylsulfone (DDS), 4,4′-diaminobenzophenone, 3,3′-diaminobenzophenone, and 4,4′-diaminobenzanilide; as well as 1,4-bis(4-aminocumyl)benzene (BAP), 1,3-bis(4-aminocumyl)benzene, 1,3-bis(3-aminophenoxy)benzene (APB), 1,4-bis(3-aminophenoxy)benzene, 1,4-bis(4-aminophenoxy)benzene, 2,2-bis[4-(4-aminophenoxy)phenyl]propane (BAPP), 2,2-bis[4-(3-aminophenoxy)phenyl]propane, bis[4-(3-aminophenoxy)phenyl]sulfone (m-APPS), bis[4-(4-aminophenoxy)phenyl]sulfone, 2,2-bis[4-(4-aminophenoxy)phenyl]hexafluoropropane, diamines represented by a general formula (1) shown below, and siloxanediamines represented by a general formula (2) shown below. These diamines can be used either alone, or in combinations comprising a plurality of different compounds. 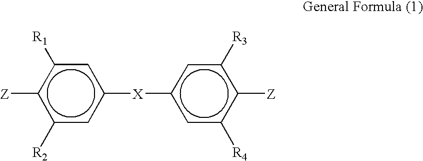
(wherein, Z represents an amino group, R₁, R₂, R₃, and R₄ each represent, independently, a hydrogen atom, or an alkyl or alkoxy group of 1 to 4 carbon atoms, provided that at least two of the groups represent an alkyl or alkoxy group, and X is a group represented by —CH₂—, —C(CH₃)₂—, —O—, —SO₂—, —CO—, or —NHCO—)

Specific examples of diamines represented by the general formula (1) include 4,4′-diamino-3,3′,5,5′-tetramethyldiphenylmethane, 4,4′-diamino-3,3′,5,5′-tetraethyldiphenylmethane, 4,4′-diamino-3,3′,5,5′-tetra-n-propyldiphenylmethane, 4,4′-diamino-3,3′,5,5′-tetraisopropyldiphenylmethane (IPDDM), 4,4′-diamino-3,3′,5,5′-tetrabutyldiphenylmethane, 4,4′-diamino-3,3′-dimethyl-5,5′-diethyldiphenylmethane, 4,4′-diamino-3,3′-dimethyl-5,5′-diisopropyldiphenylmethane, 4,4′-diamino-3,3′-diethyl-5,5′-diisopropyldiphenylmethane, 4,4′-diamino-3,5-dimethyl-3′,5′,-diethyldiphenylmethane, 4,4′-diamino-3,5-dimethyl-3′,5′-diisopropyldiphenylmethane, 4,4′-diamino-3,5-diethyl-3′,5′-diisopropyldiphenylmethane, 4,4′-diamino-3,5-diethyl-3′,5′-dibutyldiphenylmethane, 4,4′-diamino-3,5-diisopropyl-3′,5′-dibutyldiphenylmethane, 4,4′-diamino-3,3′-diisopropyl-5,5′-dibutyldiphenylmethane, 4,4′-diamino-3,3′-dimethyl-5,5′-dibutyldiphenylmethane, 4,4′-diamino-3,3′-diethyl-5,5′-dibutyldiphenylmethane, 4,4′-diamino-3,3′-dimethyldiphenylmethane, 4,4′-diamino-3,3′-diethyldiphenylmethane, 4,4′-diamino-3,3′-di-n-propyldiphenylmethane, 4,4′-diamino-3,3′-diisopropyldiphenylmethane, 4,4′-diamino-3,3′-dibutyldiphenylmethane, 4,4′-diamino-3,3′,5-trimethyldiphenylmethane, 4,4′-diamino-3,3′,5-triethyldiphenylmethane, 4,4′-diamino-3,3′,5-tri-n-propyldiphenylmethane, 4,4′-diamino-3,3′,5-triisopropyldiphenylmethane, 4,4′-diamino-3,3′,5-tributyldiphenylmethane, 4,4′-diamino-3-methyl-3′-ethyldiphenylmethane, 4,4′-diamino-3-methyl-3′-isopropyldiphenylmethane, 4,4′-diamino-3-ethyl-3′-isopropyldiphenylmethane, 4,4′-diamino-3-ethyl-3′-butyldiphenylmethane, 4,4′-diamino-3-isopropyl-3′-butyldiphenylmethane, 2,2-bis(4-amino-3,5-dimethylphenyl)propane, 2,2-bis(4-amino-3,5-diethylphenyl)propane, 2,2-bis(4-amino-3,5-di-n-propylphenyl)propane, 2,2-bis(4-amino-3,5-diisopropylphenyl)propane, 2,2-bis(4-amino-3,5-dibutylphenyl)propane, 4,4′-diamino-3,3′,5,5′-tetramethyldiphenyl ether, 4,4′-diamino-3,3′,5,5′-tetraethyldiphenyl ether, 4,4′-diamino-3,3′,5,5′-tetra-n-propyldiphenyl ether, 4,4′-diamino-3,3′,5,5′-tetraisopropyldiphenyl ether, 4,4′-diamino-3,3′,5,5′-tetrabutyldiphenyl ether, 4,4′-diamino-3,3′,5,5′-tetramethyldiphenylsulfone, 4,4′-diamino-3,3′,5,5′-tetraethyldiphenylsulfone, 4,4′-diamino-3,3′,5,5′-tetra-n-propyldiphenylsulfone, 4,4′-diamino-3,3′,5,5′-tetraisopropyldiphenylsulfone, 4,4′-diamino-3,3′,5,5′-tetrabutyldiphenylsulfone, 4,4′-diamino-3,3′,5,5′-tetramethyldiphenyl ketone, 4,4′-diamino-3,3′,5,5′-tetraethyldiphenyl ketone, 4,4′-diamino-3,3′,5,5′-tetra-n-propyldiphenyl ketone, 4,4′-diamino-3,3′,5,5′-tetraisopropyldiphenyl ketone, 4,4′-diamino-3,3′,5,5′-tetrabutyldiphenyl ketone, 4,4′-diamino-3,3′,5,5′-tetramethylbenzanilide, 4,4′-diamino-3,3′,5,5′-tetraethylbenzanilide, 4,4′-diamino-3,3′,5,5′-tetra-n-propylbenzanilide, 4,4′-diamino-3,3′,5,5′-tetraisopropylbenzanilide, and 4,4′-diamino-3,3′,5,5′-tetrabutylbenzanilide. 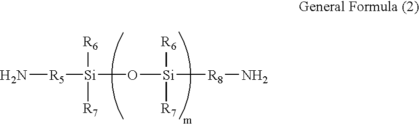
(wherein, R₅ and R₈ each represent a bivalent organic group, R₆ and R₇ each represent a monovalent organic group, and m represents an integer from 1 to 100) In the general formula (2), R₅ and R₈ preferably each represent, independently, a trimethylene group, tetramethylene group, phenylene group, or toluylene group or the like, whereas R₆ and R₇ preferably each represent, independently, a methyl group, ethyl group, or phenyl group or the like. Within the respective pluralities of R₆ and R₇ groups, groups may be either the same or different.

Siloxanediamines of the general formula (2) in which R₅ and R₈ both represent trimethylene groups, and R₆ and R₇ both represent methyl groups are available commercially for various different values of m. Compounds in which m is 1, an average of approximately 10, an average of approximately 20, an average of approximately 30, an average of approximately 50, or an average of approximately 100 are available from Shin-Etsu Chemical Co., Ltd. under the brand names LP-7100, X-22-161AS, X-22-161A, X-22-161B, X-22-161C, and X-22-161E respectively.

Examples of the aforementioned diisocyanate (A′) include compounds in which the amino groups within the above diamines have been substituted with isocyanate groups. These compounds can be used either alone, or in combinations comprising a plurality of different compounds. Furthermore, if required, mixtures of the aforementioned diamines and diisocyanates can also be used.

The acid component used in the polyamideimide or polyamide synthesis can employ a tricarboxylic acid, tetracarboxylic acid, or reactive derivative thereof (B), or a dicarboxylic acid or reactive derivative thereof (C). The component (B) preferably uses an aromatic tricarboxylic acid, aromatic tetracarboxylic acid, or reactive derivative thereof, and specific examples include monocyclic aromatic tricarboxylic acid anhydrides such as trimellitic anhydride, reactive derivatives of trimellitic anhydride such as trimellitic anhydride chloride, monocyclic aromatic tetracarboxylic acid dianhydrides such as pyromellitic dianhydride, and polycyclic aromatic tetracarboxylic acid dianhydrides such as benzophenonetetracarboxylic dianhydride, oxydiphthalic dianhydride, and bisphenol A bistrimellitate dianhydride. Furthermore, the component (C) preferably uses an aromatic dicarboxylic acid or reactive derivative thereof, and specific examples include aromatic dicarboxylic acids such as terephthalic acid and isophthalic acid, and reactive derivatives of phthalic acid such as terephthaloyl chloride and isophthaloyl chloride. These compounds can be used either alone, or in combinations comprising a plurality of different compounds.

Examples of preferred aromatic dicarboxylic acids, aromatic tricarboxylic acids, and aromatic tetracarboxylic acids and the like for use as the acid component are listed below. These compounds can be used either alone, or in combinations comprising a plurality of different compounds.

An aromatic dicarboxylic acid comprises two carboxyl groups bonded to an aromatic ring. The aromatic ring may, of course, incorporate a hetero atom, and aromatic rings may also be linked together via an alkylene group, oxygen atom, or carbonyl group or the like. In addition, the aromatic ring may also incorporate substituent groups that do not participate in condensation reactions, such as alkoxy groups, allyloxy groups, or halogen atoms. Specific examples of preferred aromatic dicarboxylic acids include terephthalic acid, isophthalic acid, 4,4′-diphenyl ether dicarboxylic acid, 4,4′-diphenylsulfone dicarboxylic acid, 4,4′-diphenyldicarboxylic acid, and 1,5-naphthalenedicarboxylic acid. Of these, terephthalic acid and isophthalic acid are preferred due to their ready availability.

Furthermore, examples of reactive derivatives of the above aromatic dicarboxylic acids include the dichlorides, dibromides, and diesters and the like of the above acids, and of these, terephthaloyl dichloride and isophthaloyl dichloride are preferred.

An aromatic tricarboxylic acid comprises three carboxyl groups bonded to an aromatic ring, wherein two of the carboxyl groups are bonded to adjacent carbon atoms. The aromatic ring may, of course, incorporate a hetero atom, and aromatic rings may also be linked together via an alkylene group, oxygen atom, or carbonyl group or the like. In addition, the aromatic ring may also incorporate substituent groups that do not participate in condensation reactions, such as alkoxy groups, allyloxy groups, or halogen atoms. Specific examples of preferred aromatic tricarboxylic acids include trimellitic acid, 3,3,4′-benzophenonetricarboxylic acid, 2,3,4′-diphenyltricarboxylic acid, 2,3,6-pyridinetricarboxylic acid, 3,4,4′-benzanilidetricarboxylic acid, 1,4,5-naphthalenetricarboxylic acid, 2′-methoxy-3,4,4′-diphenyl ether tricarboxylic acid, and 2′-chlorobenzanilide-3,4,4′-tricarboxylic acid.

Furthermore, examples of reactive derivatives of the above aromatic tricarboxylic acids include acid anhydrides, halides, esters, amides, and ammonium salts and the like of the above acids. Specific examples of these reactive derivatives include trimellitic anhydride, trimeritic anhydride monochloride, 1,4-dicarboxy-3-N,N-dimethylcarbamoylbenzene, 1,4-dicarbomethoxy-3-carboxybenzene, 1,4-dicarboxy-3-carbophenoxybenzene, 2,6-dicarboxy-3-carbomethoxypyridine, 1,6-dicarboxy-5-carbamoylnaphthalene, and ammonium salts comprising an aforementioned aromatic tricarboxylic acid, and ammonia, dimethylamine, or triethylamine or the like. Of these, trimellitic anhydride and trimellitic anhydride monochloride are preferred.

An aromatic tetracarboxylic acid comprises four carboxyl groups bonded to an aromatic ring. The aromatic ring may, of course, incorporate a hetero atom, and aromatic rings may also be linked together via an alkylene group, oxygen atom, or carbonyl group or the like. In addition, the aromatic ring may also incorporate substituent groups that do not participate in condensation reactions, such as alkoxy groups, allyloxy groups, or halogen atoms. Specific examples of preferred aromatic tetracarboxylic acids include pyromellitic acid, 3,3′,4,4′-benzophenonetetracarboxylic acid, and 3,3′,4,4′-biphenyltetracarboxylic acid.

Furthermore, examples of reactive derivatives of the above aromatic tetracarboxylic acids include pyromellitic dianhydride, 3,3′,4,4′-benzophenonetetracarboxylic dianhydride, 3,3′,4,4′-biphenyltetracarboxylic dianhydride, bis(3,4-dicarboxyphenyl) ether dianhydride, bis(3,4-dicarboxyphenyl)sulfone dianhydride, bis(3,4-dicarboxyphenoxy)diphenylsulfone dianhydride, 2,2-bisphthalic acid hexafluoroisopropylidene dianhydride, 2,2-bis[4-(3,4-dicarboxyphenoxy)phenyl]propane dianhydride, bisphenol A bistrimellitate dianhydride, 4,4′-(4,4′-isopropylidenediphenoxy)bisphthalic dianhydride, 4,4′-[1,4-phenylenebis(1-methylethylidene)]bisphenylbistrimellitate dianhydride, naphthalenetetracarboxylic dianhydride, ethylene glycol bistrimellitate dianhydride, and decamethylene glycol bistrimellitate dianhydride.

The synthesis in the present invention can employ known methods for reacting the diamine component and the acid component, and there are no particular restrictions on any of the reaction conditions, which can be set to typical values.

The weight average molecular weights of the resin A and the resin B used in the present invention are both preferably within a range from 30,000 to 130,000, and even more preferably from 35,000 to 100,000, and most preferably from 40,000 to 70,000. If the weight average molecular weight falls below 30,000, then the wetting characteristics at the time of adhesion are overly strong, which can cause excessive thickness loss of the adhesive. Furthermore, the heat resistance and the mechanical strength also tend to deteriorate, which can reduce the reflow crack resistance of the semiconductor device using the adhesive. If the molecular weight exceeds 130,000, then the wetting characteristics and adhesiveness deteriorate, which can have a negative impact on workability during the production of the semiconductor device.

The weight average molecular weight is measured by gel permeation chromatography (GPC), and refers to a polystyrene-equivalent value determined using a standard polystyrene calibration curve.

The heat resistant film used in the present invention is preferably an insulating, heat resistant, resin film such as a polyimide, polyamide, polysulfone, polyphenylene sulfide, polyetheretherketone, polyallylate, or polycarbonate. There are no particular restrictions on the thickness of this heat resistant film, which is typically within a range from 5 to 200 μm, and preferably from 20 to 75 μm.

The glass transition temperature of the heat resistant film is preferably higher than the glass transition temperature of the adhesive layer of the present invention, and is preferably at least 250° C., and even more preferably 300° C. or higher. The water absorption coefficient of the heat resistant film is preferably no more than 3% by weight, and even more preferably 2% by weight or less.

Accordingly, the heat resistant film used in the present invention is preferably an insulating, heat resistant, resin film with properties that include a glass transition temperature of at least 250° C., a water absorption coefficient of no more than 2% by weight, and a thermal expansion coefficient of no more than 3×10⁻⁵/°C., and in terms of meeting these criteria, polyimide films are particularly desirable.

The heat resistant film is preferably surface-treated prior to use. This improves the adhesive strength with the adhesive layer, and prevents peeling between the heat resistant film and the adhesive layer.

Examples of suitable methods of surface-treating the heat resistant film include chemical treatments such as alkali treatment and silane coupling treatment, physical treatments such as sand mat treatment, as well as plasma treatment or corona treatment, and the treatment best suited to the nature of the adhesive layer should be chosen. In the case of adhesive layers of the present invention, chemical and plasma treatments are particularly desirable.

There are no particular restrictions on the method used for forming the adhesive layer on the heat resistant film, and typically, the resins for forming the adhesive layer are dissolved in an organic solvent to generate an adhesive varnish (an adhesive composition), and this varnish is then applied to the surface of the heat resistant film, and heated to remove the solvent, thus forming an adhesive film with an adhesive layer formed on either one surface, or both surfaces of the heat resistant film.

Examples of suitable solvents for generating the adhesive varnish include dimethylformamide, dimethylacetamide, N-methyl-2-pyrrolidone, m-cresol, pyridine, cyclohexanone, diethylene glycol dimethyl ether, triethylene glycol dimethyl ether, tetraethylene glycol dimethyl ether, tetrahydrofuran, dioxane, ethylene glycol monobutyl ether acetate, ethyl cellosolve acetate, and toluene. These solvents can be used either alone, or in combinations of two or more different solvents.

There are no particular restrictions on the relative quantities employed when dissolving the resins in the organic solvent, but from the viewpoints of workability and achieving a favorable surface state for the adhesive layer, the resin component preferably accounts for 15 to 50% by weight of the resulting varnish. Depending on the specific resin combination selected, altering the quantity of the resin component within the varnish can also be used to control the phase-separated structure of the resulting adhesive layer.

The adhesive composition may contain only the resins A and B, or may also contain added epoxy resins, curing agents, or curing accelerators or the like. Furthermore, coupling agents or other fillers such as ceramic powders, glass powder, silver powder, copper powder, resin particles, or rubber particles may also be added to the adhesive composition.

In terms of ensuring favorable package reliability, the addition of a coupling agent is desirable, and in order to maximize the effect of the coupling agent, the resins preferably comprise reactive groups, and particularly amide groups, within the principal chain.

If fillers are added, then the quantity is preferably within a range from 1 to 30 parts by weight, and even more preferably from 5 to 15 parts by weight, per 100 parts by weight of the combination of the resin A and the resin B.

Examples of suitable coupling agents include vinylsilanes, epoxysilanes, aminosilanes, mercaptosilanes, titanates, aluminum chelates, and zirconium aluminate, and of these, silane coupling agents are preferred. Specific examples of suitable silane coupling agents include those terminated by an organic reactive group, such as vinyltrimethoxysilane, vinyltriethoxysilane, vinyl-tris(β-methoxyethoxy)silane, β-(3,4-epoxycyclohexyl)ethyltrimethoxysilane, γ-glycidoxypropyltrimethoxysilane, γ-glycidoxypropylmethyldiethoxysilane, N-β-(aminoethyl)-γ-aminopropylmethyldimethoxysilane, γ-aminopropyltriethoxysilane, N-phenyl-γ-aminopropyltrimethoxysilane and γ-mercaptopropyltrimethoxysilane. Of these, epoxysilane coupling agents containing epoxy groups are particularly desirable. In this description, an organic reactive group is a functional group such as an epoxy group, vinyl group, amino group, or mercapto group. The addition of a silane coupling agent improves the adhesion of the adhesive layer to the heat resistant film, thereby preventing peeling at the interface between the adhesive layer and the heat resistant film when the adhesive film is peeled at a temperature of 100 to 300° C. The silane coupling agent also promotes weak crosslinking between the resins, thereby strengthening the adhesive layer. The quantity added of the coupling agent is preferably within a range from 1 to 15 parts by weight, and even more preferably from 2 to 10 parts by weight, per 100 parts by weight of the combination of the resin A and the resin B.

In those cases where the heat resistant film is heated following application of the adhesive varnish, in order to remove the solvent from the varnish, any temperature capable of removing the solvent may be used.

There are no particular restrictions on the method of application, and suitable methods include roll coating, reverse roll coating, gravure coating, bar coating, and comma coating. Furthermore, the heat resistant film may also be passed through the adhesive varnish to effect application of the varnish, but control of the coating thickness tends to be difficult.

The thickness of the adhesive layer formed on the heat resistant film is preferably within a range from 1 to 75 μm, and even more preferably from 10 to 30 μm. If the thickness is less than 1 μm, then adhesion and productivity tend to deteriorate, whereas if the thickness exceeds 75 μm, the associated costs become excessive.

By using an adhesive film of the present invention, a highly reliable lead frame with an adhesive film can be manufactured easily, and at favorable yields and productivity levels. For example, a method exists in which an adhesive film of the present invention is cut into film fragments of a predetermined size, which are then bonded to lead frames. Although any cutting method capable of cutting the adhesive film precisely into fragments of a predetermined shape can be employed, from the viewpoint of workability, the adhesive film is preferably cut with a punching die, and the resulting film fragments then simply bonded to the lead frame. The adhesion temperature during bonding is typically within a range from 150 to 350° C., and preferably from 200 to 300° C. If the adhesion temperature is less than 150° C., then sufficient adhesive strength may not be achieved, whereas if the temperature exceeds 350° C., thermal degradation of the adhesive can become problematic. The bonding pressure is typically within a range from 0.1 to 20 MPa, and preferably from 0.3 to 10 MPa. If the bonding pressure is less than 0.1 MPa, then sufficient adhesive strength may not be achieved, whereas if the pressure exceeds 20 MPa, the adhesive may bleed out beyond the predetermined bonding location, causing a deterioration in the dimensional precision. The bonding pressure should be maintained for the time required to achieve favorable adhesion at the specified adhesion temperature and pressure, although taking workability into consideration, this time is preferably within a range from 0.3 to 60 seconds, and even more preferably from 0.5 to 10 seconds.

By using an adhesive film of the present invention, a highly reliable semiconductor device can also be manufactured easily, and at favorable yields and productivity levels.

For example, using a lead frame with an adhesive film prepared in the manner described above, a LOC semiconductor device can be manufactured by bonding a semiconductor chip to the opposite surface of the adhesive layer from the lead frame, connecting the lead frame and the semiconductor chip with gold wire or the like, and then sealing the structure with a molding material such as an epoxy resin using transfer molding.

The adhesion temperature for the semiconductor chip is typically within a range from 150 to 300° C., and preferably from 150 to 250° C., and even more preferably from 150 to 200° C. If this adhesion temperature is less than 150° C., then sufficient adhesive strength cannot be achieved, whereas if the temperature exceeds 300° C., thermal degradation of the semiconductor chip or the adhesive layer can become problematic. The bonding pressure is typically within a range from 0.1 to 20 MPa, and preferably from 0.3 to 10 MPa. If the bonding pressure is less than 0.1 MPa, then sufficient adhesive strength cannot be achieved, whereas if the pressure exceeds 20 MPa, the adhesive may bleed out beyond the predetermined bonding location, causing a deterioration in the dimensional precision. Furthermore, excessive pressure may also damage the semiconductor chip.

The bonding pressure should be maintained for the time required to achieve favorable adhesion at the specified adhesion temperature and pressure, although taking workability into consideration, this time is preferably within a range from 0.3 to 60 seconds, and even more preferably from 0.5 to 10 seconds.

An adhesive film according to the present invention comprises an adhesive layer formed on either one surface, or both surfaces, of a heat resistant film. This adhesive layer comprises a resin A and a resin B, selected so that the glass transition temperature of the resin A is lower than that of the resin B, and adopts a sea-island structure in which the resin A forms the sea phase, and the resin B forms the island phase. Accordingly, the adhesive film of the present invention is suitable for low temperature adhesion, and yet also has excellent wire bonding characteristics, reliability, adhesion, and adhesion workability.

Furthermore, by further specifying the types of resin within the adhesive film, an even better level of adhesion can be achieved.

By using an amide group-containing resin such as a polyamide or a polyamideimide as the resin, an adhesive film of the present invention is able to provide even better levels of adhesion and reliability.

Furthermore, by controlling the Tg for the respective resins, an even better combination of low temperature adhesion and wire bonding characteristics can be achieved.

By controlling the quantity of the silicone component within each of the resins, the sea-island structure within the adhesive film can be more easily controlled, thereby enabling a very favorable combination of low temperature adhesion and wire bonding characteristics.

Furthermore, using an adhesive film of the present invention enables the provision of a lead frame with attached adhesive film that has excellent low temperature adhesion, wire bonding characteristics, reliability, adhesiveness, and adhesion workability.

In addition, by using a lead frame with attached adhesive film such as that described above, a semiconductor device with superior reliability can be provided.

### EXAMPLES

As follows is a description of the present invention with reference to a series of examples, although the present invention is in no way limited to the examples presented here.

### (Preparation Example 1)

A four neck flask equipped with a stirrer, a thermometer, a nitrogen gas inlet, and a calcium chloride tube was charged with 1.83 g (5 mmols) of 4,4′-diamino-3,3′,5,5′-tetraisopropyldiphenylmethane (IPDDM), and 2.05 g (5 mmols) of 2,2-bis[4-(4-aminophenoxy)phenyl]propane (BAPP), which were dissolved in 28.3 g of N-methyl-2-pyrrolidone (NMP). With the solution cooled, 2.08 g (9.9 mmols) of trimellitic anhydride monochloride (TAC) was then added, with care taken to ensure that the temperature did not exceed 20° C. The mixture was then stirred for 1 hour at room temperature, and then once again cooled while 1.11 g (11 mmols) of triethylamine was added, with care taken to ensure that the temperature did not exceed 20° C. The resulting mixture was then reacted for 3 hours at room temperature, thus synthesizing a polyamic acid. The thus obtained polyamic acid varnish was then reacted for a further 6 hours at 190° C. to synthesize a polyamideimide. The polyamideimide varnish was then poured into water, and the resulting precipitate was isolated, crushed, and dried, yielding a polyamideimide copolymer powder.

Measurement of the polystyrene equivalent weight average molecular weight of this polyamideimide powder by GPC revealed a value of 60,000.

A sample of the polyamideimide powder was dissolved in NMP, and the thus obtained varnish was spread onto a glass plate. Following drying for 10 minutes at 100° C., the film was peeled off the glass, secured to an iron frame, and dried at 250° C. for a further 1 hour, thus yielding a film.

Using the thus produced film, the glass transition temperature (Tg) of the polyamideimide was measured using a thermomechanical analysis (TMA), under conditions including a load of 10 g and a rate of temperature increase of 10° C./minute, and revealed a Tg of 265° C.

### (Preparation Example 2)

A 5 liter four neck flask equipped with a thermometer, a stirrer, a nitrogen gas inlet, and a fractionating column was flushed with nitrogen, and then charged with 175.2 g (0.60 mols) of 1,3-bis(3-aminophenoxy)benzene (APB), and 352 g (0.40 mols) of a siliconediamine (brand name: X-22-161AS, manufactured by Shin-Etsu Chemical Co., Ltd.), which were then dissolved in 2400 g of diethylene glycol dimethyl ether. The resulting solution was cooled to −10° C., and with that temperature maintained, 213 g (1.00 mols) of trimellitic anhydride monochloride (TAC) was added. The mixture was then stirred for 1 hour at room temperature, and then once again cooled while 115 g of triethylamine was added, with care taken to ensure that the temperature did not exceed 20° C. The resulting mixture was then reacted for 3 hours at room temperature, thus synthesizing a polyamic acid. The thus obtained polyamic acid varnish was then reacted for a further 6 hours at 190° C. to synthesize a polyamideimide. The resulting reaction mixture was poured into methanol, and the resulting polyamideimide precipitate was isolated. This precipitate was dried, redissolved in dimethylformamide, and then once again poured into methanol to reprecipitate and isolate the polyamideimide. The thus isolated product was dried under reduced pressure, yielding a purified polysiloxane polyamideimide copolymer powder.

The weight average molecular weight of this polyamideimide powder was 47,000, and the Tg was 82° C.

### (Preparation Example 3)

A 5 liter four neck flask equipped with a thermometer, a stirrer, a nitrogen gas inlet, and a fractionating column was flushed with nitrogen, and then charged with 233.6 g (0.80 mols) of APB, and 176 g (0.20 mols) of a siliconediamine (brand name: X-22-161AS, manufactured by Shin-Etsu Chemical Co., Ltd.), which were then dissolved in 2000 g of diethylene glycol dimethyl ether. The resulting solution was cooled to −10° C., and with that temperature maintained, 213 g (1.00 mols) of trimellitic anhydride monochloride (TAC) was added. The mixture was then stirred for 1 hour at room temperature, and then once again cooled while 115 g of triethylamine was added, with care taken to ensure that the temperature did not exceed 20° C. The resulting mixture was then reacted for 3 hours at room temperature, thus synthesizing a polyamic acid. The thus obtained polyamic acid varnish was then reacted for a further 6 hours at 190° C. to synthesize a polyamideimide. The resulting reaction mixture was poured into methanol, and the resulting polyamideimide precipitate was isolated. This precipitate was dried, redissolved in dimethylformamide, and then once again poured into methanol to reprecipitate and isolate the polyamideimide. The thus isolated product was dried under reduced pressure, yielding a purified polysiloxane polyamideimide copolymer powder.

The weight average molecular weight of this polyamideimide powder was 46,000, and the Tg was 132° C.

### (Preparation Example 4)

A 5 liter four neck flask equipped with a thermometer, a stirrer, a nitrogen gas inlet, and a fractionating column was flushed with nitrogen, and then charged with 389.5 g (0.95 mols) of BAPP, and 12.5 g (0.05 mols) of a siliconediamine (brand name: LP-7100, manufactured by Shin-Etsu Chemical Co., Ltd.), which were then dissolved in 2400 g of NMP. The resulting solution was cooled to −10° C., and with that temperature maintained, 213 g (1.00 mols) of trimellitic anhydride monochloride (TAC) was added. The mixture was then stirred for 1 hour at room temperature, and then once again cooled while 115 g of triethylamine was added, with care taken to ensure that the temperature did not exceed 20° C. The resulting mixture was then reacted for 3 hours at room temperature, thus synthesizing a polyamic acid. The thus obtained polyamic acid varnish was then reacted for a further 6 hours at 190° C. to synthesize a polyamideimide. The resulting reaction mixture was poured into methanol, and the resulting polyamideimide precipitate was isolated. This precipitate was dried, redissolved in dimethylformamide, and then once again poured into methanol to reprecipitate and isolate the polyamideimide. The thus isolated product was dried under reduced pressure, yielding a purified polysiloxane polyamideimide copolymer powder.

The weight average molecular weight of this polyamideimide powder was 68,000, and the Tg was 225° C.

### (Preparation Example 5)

With the exceptions of using 2.13 g (10 mmols) of TAC, and 4.32 g (10 mmols) of bis[4-(3-aminophenoxy)phenyl]sulfone (m-APPS), a polyamideimide copolymer powder was prepared in the same manner as the preparation example 1.

The weight average molecular weight of this polyamideimide powder was 62,000, and the Tg was 222° C.

### (Preparation Example 6)

With the exceptions of using 213 g (1.00 mols) of TAC, 204.4 g (0.70 mols) of APB, and 75 g (0.30 mols) of LP-7100, a polysiloxane polyamideimide copolymer powder was prepared in the same manner as the preparation example 2.

The weight average molecular weight of this polyamideimide powder was 54,000, and the Tg was 145° C.

### (Preparation Example 7)

With the exceptions of using 213 g (1.00 mols) of TAC, 287 g (0.70 mols) of BAPP, and 75 g (0.30 mols) of LP-7100, a polysiloxane polyamideimide copolymer powder was prepared in the same manner as the preparation example 2.

The weight average molecular weight of this polyamideimide powder was 58,000, and the Tg was 175° C.

### (Preparation Example 8)

A four neck flask equipped with a stirrer, a thermometer, a nitrogen gas inlet, and a calcium chloride tube was charged with 0.2 g (1 mmol) of 4,4′-diaminodiphenyl ether (DDE), and 3.69 g (9 mmols) of BAPP, which were dissolved in 28.3 g of NMP. With the solution cooled, a mixture of 1.02 g (5 mmols) of isophthaloyl dichloride (IPC) and 1.02 g (5 mmols) of terephthaloyl dichloride (TPC) was then added, with care taken to ensure that the temperature did not exceed 20° C. The resulting mixture was then stirred for 1 hour at room temperature, and then once again cooled while 1.11 g (11 mmols) of triethylamine was added, with care taken to ensure that the temperature did not exceed 20° C. The reaction mixture was then reacted for 6 hours at room temperature, thus synthesizing a polyamide. The thus obtained polyamide varnish was poured into water, and the resulting precipitate was isolated, crushed, and dried, yielding a polyamide copolymer powder.

The weight average molecular weight of this polyamide powder was 59,000, and the Tg was 225° C.

### (Preparation Example 9)

With the exceptions of using 2.03 g (10 mmols) of IPC, and 2.48 g (10 mmols) of 4,4′-diaminodiphenylsulfone (DDS), a polyamide copolymer powder was prepared in the same manner as the preparation example 8.

The weight average molecular weight of this polyamide powder was 45,000, and the Tg was 318° C.

### (Preparation Example 10)

With the exceptions of using 2.03 g (10 mmols) of IPC, and 2.92 g (10 mmols) of APB, a polyamide copolymer powder was prepared in the same manner as the preparation example 8.

The weight average molecular weight of this polyamide powder was 53,000, and the Tg was 183° C.

### (Example 1)

A varnish produced by dissolving 30 g of the polyamideimide powder from the preparation example 1 in NMP was mixed with a varnish produced by dissolving 70 g of the polyamideimide powder from the preparation example 2 in NMP, and a silane coupling agent (brand name: SH6040, manufactured by Dow Corning Toray Silicone Co., Ltd.) was then added in a quantity equivalent to 5% by weight relative to the quantity of resin. The resulting varnish (resin content: 28% by weight) was applied to both surfaces of a chemically treated polyimide film (brand name: Upilex S, manufactured by Ube Industries, Ltd.), and was then dried at 100° C. for 10 minutes, and then at 200° C. for a further 10 minutes, thus yielding an adhesive film with an adhesive layer of thickness 25 μm on both surfaces. The film had a cloudy appearance. The adhesive layer had a Tg of 105° C., and a storage modulus at 150° C. of 8 MPa.

Inspection of a cross-section of the adhesive layer using a scanning electron microscope revealed a sea-island structure, with the polyamideimide of the preparation example 1 forming the islands, and the polyamideimide of the preparation example 2 forming the sea. The average size of the islands was 3 μm.

In the present invention, measurements of the storage modulus were conducted using a DVE Rheospectra device, manufactured by Rheology Co., Ltd., using conditions including a frequency of 10 Hz, an amplitude of 10 μm, and automatic control of the tensile load.

The adhesive film was cut into rectangular strips using a punching die, and one such strip was positioned on top of an iron-nickel alloy lead frame of thickness 0.2 mm so as to contact inner leads of width 0.2 mm and spacing 0.2 mm. The rectangular strip of adhesive film was then pressure bonded at 230° C. under a pressure of 3 MPa for 3 seconds, thus producing a lead frame with an adhesive film.

Subsequently, a semiconductor element was pressure bonded to the adhesive layer surface of this lead frame with attached adhesive film, at a temperature of 200° C. and under a pressure of 3 MPa for 3 seconds. The lead frame and the semiconductor element were then wire bonded at 160° C. using gold wire, and no wire bonding defects occurred. The structure was then sealed by transfer molding, using a biphenyl-based epoxy resin molding material (brand name: CEL-9200, manufactured by Hitachi Chemical Co., Ltd.), thus yielding a semiconductor device (package) such as that shown in FIG. 2.

This package was subjected to moisture absorption treatment in an atmosphere at 85° C. and 85% RH for 48 hours, and was then passed through a solder reflow oven at 245° C., but no cracks occurred in the package.

In FIG. 2, numeral 3 represents an adhesive film, numeral 4 a semiconductor element, numeral 5 a lead frame, numeral 6 a sealing resin, numeral 7 a bonding wire, and numeral 8 a bus bar.

### (Comparative Example 1)

With the exception of using only the resin from the preparation example 2, an adhesive film was prepared in the same manner as the example 1.

This film appeared transparent, and the adhesive layer had a Tg of 82° C., and a storage modulus at 150° C. of 0.8 MPa.

Using this adhesive film, a semiconductor device was prepared in the same manner as the example 1, but during the wire bonding step, a plurality of wire bonding defects occurred.

### (Comparative Example 2)

With the exception of using only the resin from the preparation example 1, an adhesive film was prepared in the same manner as the example 1.

This film appeared transparent, and the adhesive layer had a Tg of 265° C., and a storage modulus at 150° C. of 2.1 GPa. Using this adhesive film, a semiconductor device was prepared in the same manner as the example 1, but in the die bonding step, the chip and the lead frame could not be bonded together at an adhesion temperature of 200° C.

### (Example 2)

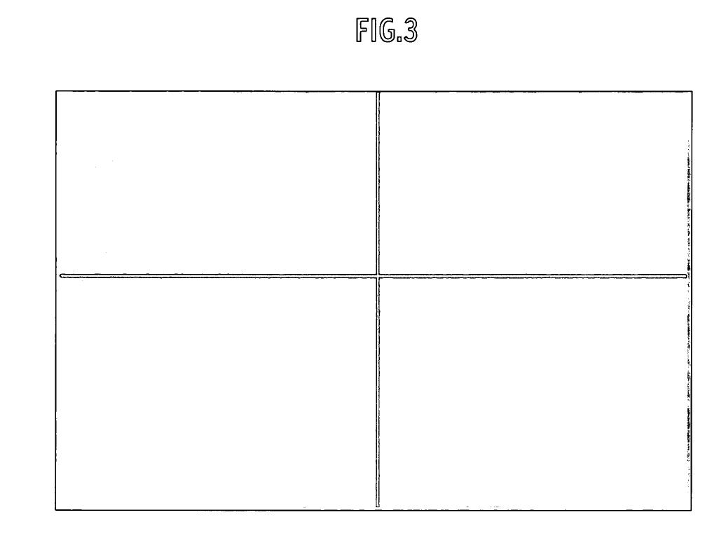

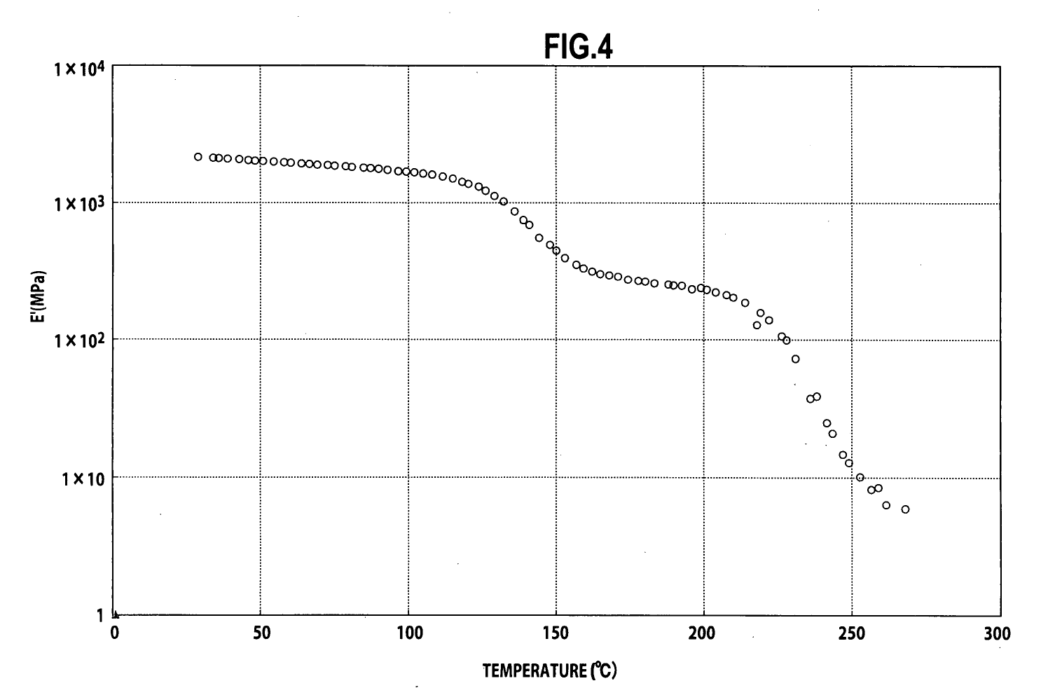

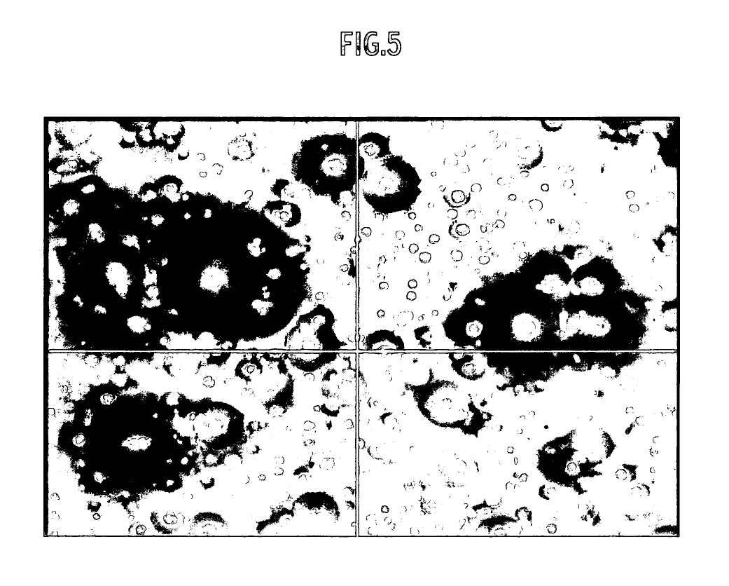

With the exceptions of using 30 g of the polyamideimide powder from the preparation example 1 and 70 g of the polyamideimide powder from the preparation example 3, and adjusting the resin content of the varnish to 20% by weight, an adhesive film was produced in the same manner as the example 1. This film had a cloudy appearance. The adhesive layer had a Tg of 145° C., and a storage modulus at 150° C. of 800 MPa. A photograph of the exterior (of the surface of the adhesive layer, as viewed under an optical microscope), and a graph showing the elastic modulus of the adhesive layer are shown in FIG. 3 and FIG. 4 respectively. The photograph confirms the existence of sea and island phases within the adhesive layer. The graph of the elastic modulus clearly shows inflection points corresponding with the respective resins prior to mixing.

Inspection of a cross-section of the adhesive layer using a scanning electron microscope revealed a sea-island structure, with the polyamideimide of the preparation example 1 forming the islands, and the polyamideimide of the preparation example 3 forming the sea.

The adhesive film was cut into rectangular strips using a punching die, and one such strip was positioned on top of an iron-nickel alloy lead frame of thickness 0.2 mm so as to contact inner leads of width 0.2 mm and spacing 0.2 mm. The rectangular strip of adhesive film was then pressure bonded at 230° C. under a pressure of 3 MPa for 3 seconds, thus producing a lead frame with an adhesive film.

Subsequently, a semiconductor element was pressure bonded to the adhesive layer surface of this lead frame with attached adhesive film, at a temperature of 200° C. and under a pressure of 3 MPa for 3 seconds. The lead frame and the semiconductor element were then wire bonded at 160° C. using gold wire, and no wire bonding defects occurred. The structure was then sealed by transfer molding, using a biphenyl-based epoxy resin molding material (brand name: CEL-9200, manufactured by Hitachi Chemical Co., Ltd.), thus yielding a semiconductor device (package) such as that shown in FIG. 2.

This package was subjected to moisture absorption treatment in an atmosphere at 85° C. and 85% RH for 48 hours, and was then passed through a solder reflow oven at 245° C., but no cracks occurred in the package.

### (Example 3)

With the exceptions of using 30 g of the polyamideimide powder from the preparation example 4, and 70 g of the polyamideimide powder from the preparation example 3, an adhesive film was produced in the same manner as the example 1. This film had a cloudy appearance. A photograph of the exterior (of the surface of the adhesive layer, as viewed under an optical microscope), is shown in FIG. 5. The adhesive layer had a Tg of 138° C., and a storage modulus at 150° C. of 750 MPa.

Inspection of a cross-section of the adhesive layer using a scanning electron microscope revealed a sea-island structure, with the polyamideimide of the preparation example 4 forming the islands, and the polyamideimide of the preparation example 3 forming the sea.

The adhesive film was cut into rectangular strips using a punching die, and one such strip was positioned on top of an iron-nickel alloy lead frame of thickness 0.2 mm so as to contact inner leads of width 0.2 mm and spacing 0.2 mm. The rectangular strip of adhesive film was then pressure bonded at 230° C. under a pressure of 3 MPa for 3 seconds, thus producing a lead frame with an adhesive film.

Subsequently, a semiconductor element was pressure bonded to the adhesive layer surface of this lead frame with attached adhesive film, at a temperature of 200° C. and under a pressure of 3 MPa for 3 seconds. The lead frame and the semiconductor element were then wire bonded at 160° C. using gold wire, and no wire bonding defects occurred. The structure was then sealed by transfer molding, using a biphenyl-based epoxy resin molding material (brand name: CEL-9200, manufactured by Hitachi Chemical Co., Ltd.), thus yielding a semiconductor device (package) such as that shown in FIG. 2.

This package was subjected to moisture absorption treatment in an atmosphere at 85° C. and 85% RH for 48 hours, and was then passed through a solder reflow oven at 245° C., but no cracks occurred in the package.

### (Example 4)

With the exceptions of using 15 g of the polyamideimide powder from the preparation example 1 and 85 g of the polyamideimide powder from the preparation example 3, and adjusting the resin content of the varnish to 33% by weight, an adhesive film was produced in the same manner as the example 1. This film had a cloudy appearance. The adhesive layer had a Tg of 136° C., and a storage modulus at 150° C. of 740 MPa.

Inspection of a cross-section of the adhesive layer using a scanning electron microscope revealed a sea-island structure, with the polyamideimide of the preparation example 1 forming the islands, and the polyamideimide of the preparation example 3 forming the sea.

The adhesive film was cut into rectangular strips using a punching die, and one such strip was positioned on top of an iron-nickel alloy lead frame of thickness 0.2 mm so as to contact inner leads of width 0.2 mm and spacing 0.2 mm. The rectangular strip of adhesive film was then pressure bonded at 230° C. under a pressure of 3 MPa for 3 seconds, thus producing a lead frame with an adhesive film.

Subsequently, a semiconductor element was pressure bonded to the adhesive layer surface of this lead frame with attached adhesive film, at a temperature of 200° C. and under a pressure of 3 MPa for 3 seconds. The lead frame and the semiconductor element were then wire bonded at 160° C. using gold wire, and no wire bonding defects occurred. The structure was then sealed by transfer molding, using a biphenyl-based epoxy resin molding material (brand name: CEL-9200, manufactured by Hitachi Chemical Co., Ltd.), thus yielding a semiconductor device (package) such as that shown in FIG. 2.

This package was subjected to moisture absorption treatment in an atmosphere at 85° C. and 85% RH for 48 hours, and was then passed through a solder reflow oven at 245° C., but no cracks occurred in the package.

### (Comparative Example 3)

With the exceptions of using 70 g of the polyamideimide powder from the preparation example 1, and 30 g of the polyamideimide powder from the preparation example 2, an adhesive film was produced in the same manner as the example 1. This film had a cloudy appearance. The adhesive layer had a Tg of 235° C., and a storage modulus at 150° C. of 1.2 GPa.

Inspection of a cross-section of the adhesive layer using a scanning electron microscope revealed a sea-island structure, with the polyamideimide of the preparation example 2 forming the islands, and the polyamideimide of the preparation example 1 forming the sea.

Using this adhesive film, a semiconductor device was prepared in the same manner as the example 1, but in the die bonding step, the chip and the lead frame could not be bonded together at an adhesion temperature of 200° C.

### (Example 5)

With the exceptions of using 30 g of the polyamide powder from the preparation example 8, and 70 g of the polyamideimide powder from the preparation example 2, a mixed varnish and an adhesive film were produced in the same manner as the example 1. Significant phase separation was evident even at the mixed varnish stage, and the external appearance of the adhesive film also showed significant phase separation.

### (Example 6)

With the exceptions of using 30 g of the polyamide powder from the preparation example 9, and 70 g of the polyamideimide powder from the preparation example 2, a mixed varnish and an adhesive film were produced in the same manner as the example 1. Significant phase separation was evident even at the mixed varnish stage, and the external appearance of the adhesive film also showed significant phase separation.

### (Example 7)

With the exceptions of using 30 g of the polyamideimide powder from the preparation example 1, and 70 g of the polyamideimide powder from the preparation example 6, an adhesive film was produced in the same manner as the example 1. This film had a cloudy appearance. The adhesive layer had a Tg of 146° C., and a storage modulus at 150° C. of 1.0 GPa.

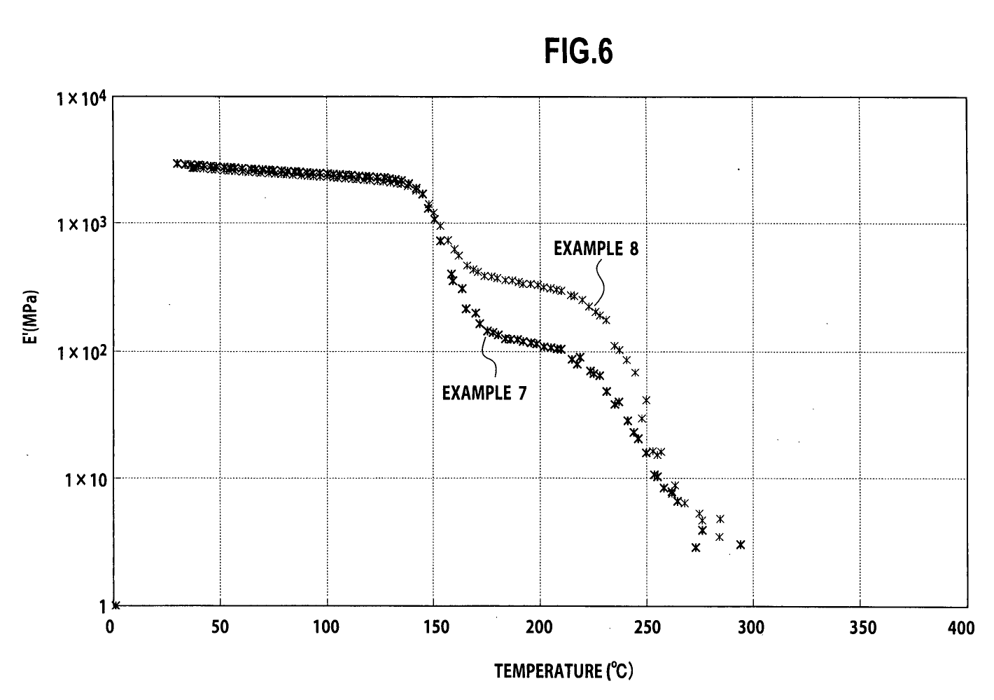

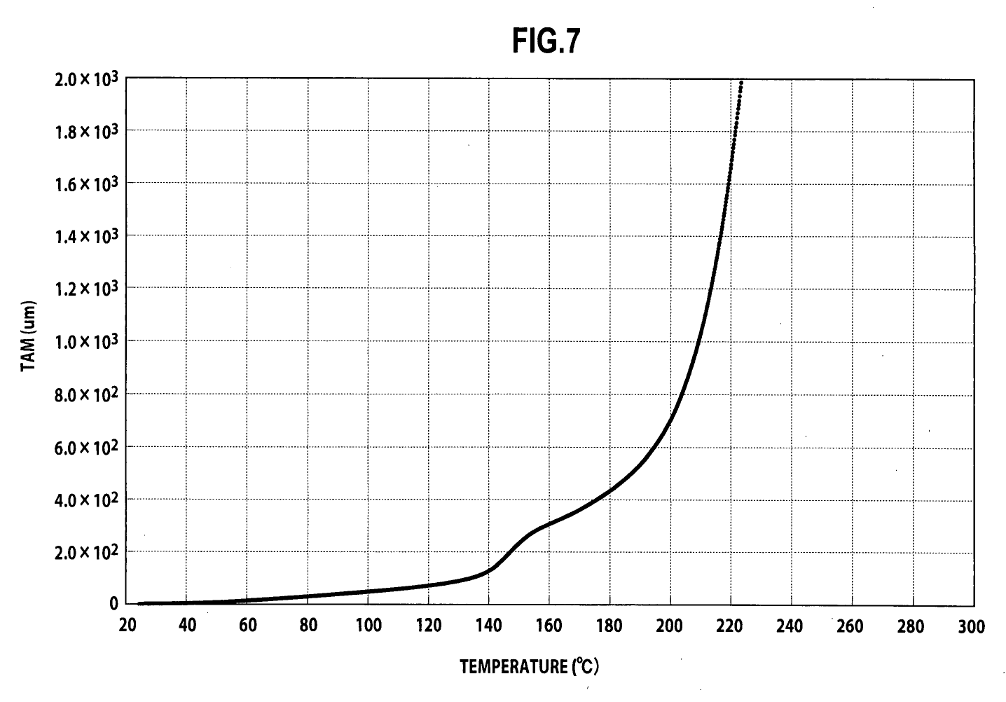

A graph showing the elastic modulus of the film, and a TMA chart showing the results for the tensile mode of a thermomechanical analysis (TMA) are shown in FIG. 6 and FIG. 7 respectively. The graph of the elastic modulus clearly shows inflection points corresponding with the respective resins prior to mixing. Inspection of a cross-section of the adhesive layer using a scanning electron microscope revealed a sea-island structure, with the polyamideimide of the preparation example 1 forming the islands, and the polyamideimide of the preparation example 6 forming the sea.

The adhesive film was cut into rectangular strips using a punching die, and one such strip was positioned on top of an iron-nickel alloy lead frame of thickness 0.2 mm so as to contact inner leads of width 0.2 mm and spacing 0.2 mm. The rectangular strip of adhesive film was then pressure bonded at 250° C. under a pressure of 3 MPa for 3 seconds, thus producing a lead frame with an adhesive film.

Subsequently, a semiconductor element was pressure bonded to the adhesive layer surface of this lead frame with attached adhesive film, at a temperature of 230° C. and under a pressure of 3 MPa for 3 seconds. The lead frame and the semiconductor element were then wire bonded at 160° C. using gold wire, and no wire bonding defects occurred. The structure was then sealed by transfer molding, using a biphenyl-based epoxy resin molding material (brand name: CEL-9200, manufactured by Hitachi Chemical Co., Ltd.), thus yielding a semiconductor device (package) such as that shown in FIG. 2.

This package was subjected to moisture absorption treatment in an atmosphere at 85° C. and 85% RH for 48 hours, and was then passed through a solder reflow oven at 245° C., but no cracks occurred in the package.

### (Example 8)

With the exceptions of using 40 g of the polyamideimide powder from the preparation example 1, and 60 g of the polyamideimide powder from the preparation example 6, an adhesive film was produced in the same manner as the example 1. This film had a cloudy appearance. The adhesive layer had a Tg of 146° C., and a storage modulus at 150° C. of 1.05 GPa.

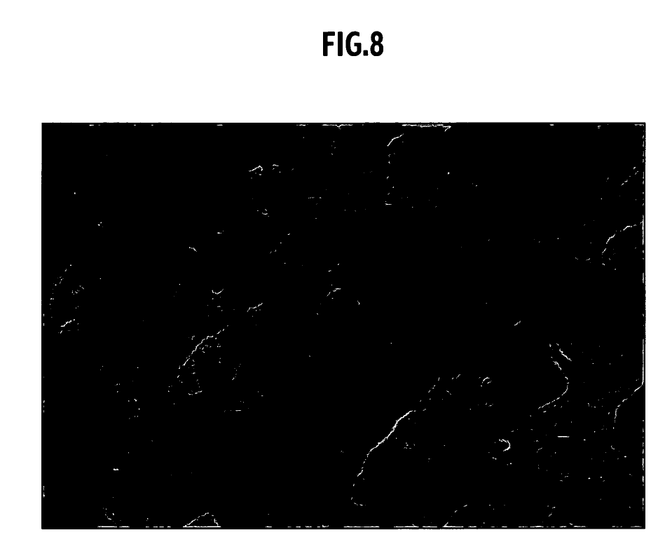

A graph showing the elastic modulus of the film is shown in FIG. 6. This graph of the elastic modulus clearly shows inflection points corresponding with the respective resins prior to mixing. Inspection of a cross-section of the adhesive layer using a scanning electron microscope revealed a sea-island structure, with the polyamideimide of the preparation example 1 forming the islands, and the polyamideimide of the preparation example 6 forming the sea. The scanning electron microscope photograph is shown in FIG. 8.

The thus produced adhesive film had extremely good slipperiness, and generated almost no static electricity.

The adhesive film was cut into rectangular strips using a punching die, and one such strip was positioned on top of an iron-nickel alloy lead frame of thickness 0.2 mm so as to contact inner leads of width 0.2 mm and spacing 0.2 mm. The rectangular strip of adhesive film was then pressure bonded at 250° C. under a pressure of 3 MPa for 3 seconds, thus producing a lead frame with an adhesive film.

Subsequently, a semiconductor element was pressure bonded to the adhesive layer surface of this lead frame with attached adhesive film, at a temperature of 230° C. and under a pressure of 3 MPa for 3 seconds. The lead frame and the semiconductor element were then wire bonded at 160° C. using gold wire, and no wire bonding defects occurred. The structure was then sealed by transfer molding, using a biphenyl-based epoxy resin molding material (brand name: CEL-9200, manufactured by Hitachi Chemical Co., Ltd.), thus yielding a semiconductor device (package) such as that shown in FIG. 2.

This package was subjected to moisture absorption treatment in an atmosphere at 85° C. and 85% RH for 48 hours, and was then passed through a solder reflow oven at 245° C., but no cracks occurred in the package.

### (Example 9)

With the exceptions of using 15 g of the polyamideimide powder from the preparation example 5, and 85 g of the polyamideimide powder from the preparation example 7, an adhesive film was produced in the same manner as the example 1. This film had a cloudy appearance. The adhesive layer had a Tg of 177° C.

Inspection of a cross-section of the adhesive layer using a scanning electron microscope revealed a sea-island structure, with the polyamideimide of the preparation example 5 forming the islands, and the polyamideimide of the preparation example 7 forming the sea.

### (Example 10)

With the exceptions of using 20 g of the polyamide powder from the preparation example 10, and 80 g of the polyamideimide powder from the preparation example 6, an adhesive film was produced in the same manner as the example 1. This film had a cloudy appearance. The adhesive layer had a Tg of 146° C.

Inspection of a cross-section of the adhesive layer using a scanning electron microscope revealed a sea-island structure, with the polyamide of the preparation example 10 forming the islands, and the polyamideimide of the preparation example 6 forming the sea.

The Table 1 below summarizes the information relating to the above examples.

| | Prepa- | Composition | | | | Compar- | Compar- | | | | Compar- |
|---|---|---|---|---|---|---|---|---|---|---|---|
| | ration | (values in brackets show | | | | ative | ative | | | | ative |
| Resin | example | molar ratio) | Tg | Mw | Example 1 | example 1 | example 2 | Example 2 | Example 3 | Example 4 | example 3 |
| A | 2 | TAC(10)/APB(6)/161AS (4) | 82 | 47k | 70 | 100 | | | | | 30 |
| A | 3 | TAC(10)/APB(8)/161AS (2) | 132 | 46k | | | | 70 | 70 | 85 | |
| A | 6 | TAC(10)/APB(7)/LP(3) | 145 | 54k | | | | | | | |
| A | 7 | TAC(10)/BAPP(7)/LP(3) | 175 | 58k | | | | | | | |
| B | 1 | TAC(10)/IPDDM(5)/BAPP(5) | 265 | 60k | 30 | | 100 | 30 | | 15 | 70 |
| B | 4 | TAC(10)/BAPP(9.5)/LP(0.5) | 225 | 68k | | | | | 30 | | |
| B | 5 | TAC(10)/m-APPS(10) | 222 | 62k | | | | | | | |
| B | 8 | IPC(5)/TPC(5)/BAPP(9)/ | 225 | 59k | | | | | | | |
| | | DDE(1) | | | | | | | | | |
| B | 9 | IPC(10)/DDS(10) | 318 | 45k | | | | | | | |
| B | 10 | IPC(10)/APB(10) | 183 | 53k | | | | | | | |
| | | SH6040 (silane coupling agent) | | | 5 | | | 5 | 5 | 5 | |

| | | | | | | | |
|---|---|---|---|---|---|---|---|
| Resin fraction within varnish | 28 | 28 | 28 | 20 | 28 | 33 | 28 |
| (% by weight) | | | | | | | |
| Film construction | 3 layers | 3 layers | 3 layers | 3 layers | 3 layers | 3 layers | 3 layers |
| External appearance (visual) | cloudy | clear | clear | cloudy | cloudy | cloudy | cloudy |
| Islands-in-sea structure | Yes | No | No | Yes | Yes | Yes | Yes |
| Tg | 105° C. | 82° C. | 265° C. | 145° C. | 138° C. | 136° C. | 235° C. |
| E′ (150° C.) | 8 Mpa | 0.8 | 2.1 GPa | 800 | 750 | 740 | 1.2 GPa |
| | | MPa | | MPa | MPa | MPa | |
| 200° C. adhesion | good | good | poor | good | good | good | poor |
| Wire bonding defects | none | many | — | none | none | none | — |
| Package cracking | none | — | — | none | none | none | — |

| | | Composition | | | | | | | | |
|---|---|---|---|---|---|---|---|---|---|---|
| | Preparation | (values in brackets show | | | | | | | | |
| Resin | example | molar ratio) | Tg | Mw | Example 5 | Example 6 | Example 7 | Example 8 | Example 9 | Example 10 |
| A | 2 | TAC(10)/APB(6)/161AS (4) | 82 | 47k | 70 | 70 | | | | |
| A | 3 | TAC(10)/APB(8)/161AS (2) | 132 | 46k | | | | | | |
| A | 6 | TAC(10)/APB(7)/LP(3) | 145 | 54k | | | 70 | 60 | | 80 |
| A | 7 | TAC(10)/BAPP(7)/LP(3) | 175 | 58k | | | | | 85 | |
| B | 1 | TAC(10)/IPDDM(5)/BAPP(5) | 265 | 60k | | | 30 | 40 | | |
| B | 4 | TAC(10)/BAPP(9.5)/LP(0.5) | 225 | 68k | | | | | | |
| B | 5 | TAC(10)/m-APPS(10) | 222 | 62k | | | | | 15 | |
| B | 8 | IPC(5)/TPC(5)/BAPP(9)/ | 225 | 59k | 30 | | | | | |
| | | DDE(1) | | | | | | | | |
| B | 9 | IPC(10)/DDS(10) | 318 | 45k | | 30 | | | | |
| B | 10 | IPC(10)/APB(10) | 183 | 53k | | | | | | 20 |
| | | SH6040 (silane coupling agent) | | | 5 | 5 | 5 | 5 | 5 | 5 |

| | | | | | | |
|---|---|---|---|---|---|---|
| Resin fraction within varnish | 28 | 28 | 28 | 28 | 28 | 28 |
| (% by weight) | | | | | | |
| Film construction | 3 layers | 3 layers | 3 layers | 3 layers | 3 layers | 3 layers |
| External appearance (visual) | separate | separate | cloudy | cloudy | cloudy | cloudy |
| | phases | phases | | | | |
| Islands-in-sea structure | Yes | Yes | Yes | Yes | Yes | Yes |
| Tg | — | — | 146° C. | 148° C. | 177° C. | 146° C. |
| E′ (150° C.) | — | — | 1 GPa | 1.05 | — | — |
| | | | | GPa | | |
| 200° C. adhesion | — | — | good | good | — | — |
| Wire bonding defects | — | — | none | none | — | — |
| Package cracking | — | — | none | none | — | — |

1. An adhesive film used for bonding a semiconductor element to a target adherend, wherein
said adhesive film comprises an adhesive layer formed on one surface, or both surfaces, of a heat resistant film,
said adhesive layer comprises a resin A and a resin B,
a glass transition temperature of said resin A is lower than a glass transition temperature of said resin B, and
said adhesive layer has a sea-island structure, in which said resin A forms said sea, and said resin B forms said islands.

2. The adhesive film according to claim 1, wherein one of said resin A and said resin B is a polyamideimide, a polyamide, an aromatic polyester, a polysulfone, a polyethersulfone, or a mixed resin thereof comprising two or more different materials.

3. The adhesive film according to claim 1, wherein both said resin A and said resin B are a polyamideimide, a polyamide, an aromatic polyester, a polysulfone, a polyethersulfone, or a mixed resin thereof comprising two or more different materials.

4. The adhesive film according to claim 1, wherein at least one of said resin A and said resin B is a polyamideimide, a polyamide, or a mixed resin thereof.

5. The adhesive film according to claim 1, wherein said resin A is a polyamideimide, a polyamide, or a mixed resin thereof.

6. The adhesive film according to claim 1, wherein said resin A is a polymer produced by polymerization of a monomer component comprising from 10 to 80% by weight of monomers with a silicone structure.

7. The adhesive film according to claim 6, wherein said resin B is a polymer produced by polymerization of a monomer component comprising 0% or more but less than 10% by weight of monomers with a silicone structure.

8. The adhesive film according to claim 1, wherein a glass transition temperature of said resin A is at least 30° C. but less than 200° C., and a glass transition temperature of said resin B is within a range from 200 to 400° C.

9. The adhesive film according to claim 8, wherein a difference between said glass transition temperatures of said resin A and said resin B is within a range from 20 to 300° C.

10. The adhesive film according to claim 1, wherein a storage modulus of said adhesive layer is within a range from 3 MPa to 10 GPa at a temperature of 150° C. or higher.

11. The adhesive film according to claim 1, wherein said adhesive layer comprises a coupling agent.

12. The adhesive film according to claim 11, wherein said coupling agent is a silane coupling agent.

13. A lead frame with an adhesive film, comprising a lead frame, and the adhesive film according to claim 1 bonded to said lead frame.

14. A semiconductor device in which a lead frame and a semiconductor element are bonded together using the adhesive film according to claim 1.
